(19) United States
(12) Patent Application Publication
(10) Pub. No.: US 2026/0226925 A1
(43) Pub. Date: Aug. 6, 2026

(54) ACTUATOR SYSTEM, AIRCRAFT, AND METHOD

(71) Applicant: Liebherr-Aerospace Lindenberg GmbH, Lindenberg (DE)

(72) Inventors: Thomas IMMLER, Sigmarszell (DE); Christian SCHILLING, Maierhöfen (DE); Julian KINZELMANN, Hergensweiler (DE); Frank KRONBURGER, Lindenberg (DE)

(21) Appl. No.: 19/530,994

(22) Filed: Feb. 5, 2026

(30) Foreign Application Priority Data
Feb. 6, 2025 (DE) 10 2025 104 430.9

(51) Int. Cl. F15B 21/08; H02M 1/00

(52) U.S. Cl. CPC F15B 21/087; H02M 1/0003; F15B 2211/6655

(57) ABSTRACT

The present disclosure relates to an actuator system, having an actuator that includes a conversion unit for converting electrical and/or hydraulic power into mechanical power, and a control unit for supplying the conversion unit with electrical power and/or for controlling the conversion unit. The actuator system comprises an electronics unit arranged separately from the power unit configured to detect one or more states of the actuator and/or the conversion unit, convert the detected state or states into data, and transmit the data digitally to the control unit. The electronics unit comprises a memory in which one or more properties of the actuator and/or the conversion unit are stored as data, and the electronics unit is configured to transmit one, multiple or all of the stored data to the control unit. The control unit is configured to regulate and/or control the actuator and/or the conversion unit.

### CROSS REFERENCE TO RELATED APPLICATION

The present application claims priority to German Patent Application No. 10 2025 104 430.9 filed on Feb. 6, 2025. The entire contents of the above-listed application are hereby incorporated by reference for all purposes.

### TECHNICAL FIELD

The present disclosure relates to an actuator system, for example, for an aircraft, comprising an actuator that has a conversion unit for converting electrical and/or hydraulic power into mechanical power, and a control unit for supplying the conversion unit with electrical power and/or for controlling the conversion unit.

### BACKGROUND

It is known from the prior art that functions for reading sensors of an actuator and controlling the actuator are implemented in a computing unit, often referred to as an “Actuator Control Electronics” (ACE), for the actuator.

### SUMMARY

According to the prior art, this computing unit can be integrated in a “cabinet” or arranged near the actuator, on the actuator, or integrated into the actuator.

For example, EP 3 273 592 A1 or EP 3 273 593 A1 disclose that various functions for operating the actuator are implemented in units arranged separately from each other due to space or environmental conditions, e.g. with power electronics in one unit and signal electronics in a separate unit.

EP 4 415 248 A1 discloses an actuator control system with a plurality of identical sensors that are read out via a signal electronics. In EP 4 415 248 A1, at least two identical motor position sensors and at least two identical actuator output position sensors are provided.

A disadvantage of the known solutions is, inter alia, the extensive wiring effort, the high susceptibility of analog signals to interference, and the need for specific interfaces for connecting sensors.

Against this background, the present disclosure is based on the object of improving an actuator system of the type mentioned above, particularly with regard to the system architecture.

This object is achieved by the subject matter described herein.

Accordingly, the disclosure provides that the actuator system comprises an electronics unit arranged separately from the power unit, which is configured to detect one or more states of the actuator and/or the conversion unit, convert the detected state or states into data, and transmit the data digitally to the control unit. The electronics unit comprises a memory in which one or more properties of the actuator and/or the conversion unit are stored as data, and the electronics unit is configured to transmit one, multiple, or all of the stored data to the control unit, for example, upon request of the control unit. The control unit, in particular based on data transmitted by the actuator and/or the electronics unit and/or based on control commands transmitted to the control unit, is configured to regulate and/or control the actuator and/or the conversion unit.

The electronics unit is optionally implemented as “simple” electronics and/or has no microcontroller or FPGA.

The electronics unit optionally comprises a memory for actuator data. For example, lifetime data and calibration data for the actuator can be stored in the memory. Optionally, a memory is present on the actuator.

The electronics unit can be configured to store actuator-specific properties and configurations in the form of data, and can be configured to transmit this data digitally to the control unit.

The electronics unit is optionally fixed to a stable part of the actuator, thus allowing a modular design. The electronics unit is optionally implemented according to a standard.

Optionally, a splitting of the functions necessary for controlling the actuator is carried out by implementing these functions on separate units, for example, for better integration of the actuator system into an aircraft or for a better use of space. Optionally, the electronics unit is connected to the control unit via a standardized interface.

Optionally, one or more pieces of information about the state of the actuator are collected via the electronics unit and transmitted digitally to the control unit.

The control unit can be referred to as an “Actuator Control Electronics” (ACE).

The electronics unit can be referred to as a small “Remote Electronic Unit” (REU) or as a Nano-REU (nREU).

The electronics unit is optionally a small integrable electronic device for digitizing the interfaces of the actuator.

Multiple electronics units can be arranged distributed on or in the actuator, for example, for better utilization of space.

Optionally, reusability and modularization are possible.

Optionally, the control unit and the electronics unit each have a digital communication interface and are connected via these communication interfaces to transmit data from the electronics unit to the control unit and/or to transmit data from the control unit to the electronics unit.

The electronics unit optionally comprises a digital interface.

The digital interface is optionally configured to transmit information or data digitally to the control unit.

The electronics unit and the control unit are optionally connected via the digital interface.

The electronics unit can transmit or send data via the digital interface, e.g. to the control unit, and/or can receive data via the digital interface, e.g. from the control unit.

The digital interface can be configured to transmit data via light, wirelessly, via radio, and/or serially. Transmission may occur via optical, wireless (radio) or serial communication.

Due to limited space, in one conceivable embodiment only a part of the functions necessary for controlling the actuator can be integrated and/or arranged on the actuator in units that are configured to perform these functions. In one conceivable embodiment, the units which are each configured to perform functions necessary for controlling the actuator are arranged distributed in the actuator system.

The control unit can be arranged at different locations.

For example, the control unit can be arranged at a location other than the electronics unit on or at the actuator, for instance on an end face of the actuator.

The control unit can be arranged near the actuator on a “rear spar” of the aircraft.

The control unit can be arranged in the avionics bay of the aircraft.

The control unit can be arranged in the wing or fuselage of the aircraft.

The control unit and the electronics unit are optionally connected to each other via a bus connection.

By using bus connections, the wiring effort is advantageously reduced.

Optionally, the electronics unit is configured to execute simple actuations in the form of a digital on-off control, for example, opening a power path and/or switching a locking unit, for example, a brake.

The electronics unit is optionally configured to take over simple on/off control tasks, such as opening a power path or switching a locking unit such as a brake.

Optionally, the electronics unit can perform simple control tasks, for example brake actuation. The electronics unit optionally has a power supply for analog voltages, which is configured, for example, to drive a servo amplifier and/or to supply sensors with voltage.

Optionally, the state or states of the actuator include a position of the conversion unit, a position of the actuator, for example of a mechanical actuator output, a temperature of the actuator, a force acting on the actuator, a torque acting on the actuator, an electrical voltage applied to the actuator, an electric current flowing through the actuator, and/or one or more other quantities such as an acceleration and/or a humidity.

One or more states of the actuator and/or the conversion unit can optionally be detected by the electronics unit via sensors. These state variables can include, for example, a motor position, an actuator position, an actuator temperature, an actuator force, an actuator current, an actuator voltage, and/or additional environmental information such as acceleration or humidity.

The actuator optionally has stable interfaces for sensing the motor position, actuator position, temperature, and/or force.

Optionally, the wiring effort between the control unit and the actuator is reduced.

Optionally, functions of an actuator system are split across different units.

Optionally, the actuator has one or more additional mechanical and/or hydraulic conversion units.

Optionally, the control unit has a power stage which is configured to supply the conversion unit with electrical energy.

In the context of the disclosure, the terms “energy” and “power” are may be used interchangeably.

The electronics unit can be powered by the control unit, or its power supply can also be provided external to the actuator system.

The electronics unit can also be powered via the motor phases of an electric motor of the actuator.

The control unit optionally comprises a controller and a power stage. Optionally, the actuator and/or the electronics unit have no power stage.

Optionally, the actuator system comprises one or more sensors which are connected to the electronics unit and arranged such that the electronics unit can detect the state or states of the actuator and/or the conversion unit by means of the sensor(s). In this context, each sensor is configured and arranged to detect one or more of the states. Optionally, the sensor data are digitized on the actuator at the measurement location, and the sensors are implemented as “smart” sensors.

The sensor or sensors are optionally connected to the electronics unit via a standard interface.

Optionally, for detecting at least one state of the actuator, for example, for detecting the position of the conversion unit and/or the position of the actuator, for example of the mechanical actuator output, only exactly one sensor is provided in each case.

Optionally, the actuator system (per conversion unit) has at most only exactly one conversion-unit position sensor, for example a motor position sensor and at most only exactly one actuator position sensor. Optionally, only a single motor position sensor is present and/or a sensorless control is implemented.

Optionally, the reading of states or state variables of an actuator captured by a sensor is performed such that for each state exactly one sensor is provided. For example, for detecting a given position of the actuator, optionally exactly one sensor is provided.

Optionally, the electronics unit is part of the actuator and/or is arranged in one structural unit with the actuator and/or the conversion unit.

Optionally, all components of the actuator system are arranged in one structural unit, or at least one component of the actuator system, in particular the control unit, is arranged separately from the other components of the actuator system.

Optionally, the conversion unit is an electric motor, for example a permanent-magnet synchronous motor, or a hydraulic unit with a hydraulic valve, for example a servo valve, and a hydraulic cylinder.

Optionally, the actuator comprises a gearbox and/or a spindle, wherein the conversion unit is configured and arranged to drive the gearbox and/or the gearbox is configured and arranged to drive the spindle. Alternatively, the actuator has a hydraulic pump and/or a hydraulic cylinder, wherein the conversion unit is configured and arranged to drive the hydraulic pump and/or the hydraulic pump is configured and arranged to drive and/or supply the hydraulic cylinder.

The actuator can be an electromechanical actuator (EMA), an electrohydraulic actuator (EHA), a servo-hydraulic actuator (SHA), or an electric motor pump (EMP).

The actuator may include one conversion unit, for example an electromagnetic conversion unit that converts electrical power into mechanical power, and may include one or more additional mechanical and/or hydraulic conversion units.

The mechanical conversion unit can be an electromagnetically actuatable locking unit, for example a brake.

The hydraulic conversion unit can be an electromagnetically actuatable valve.

The actuator is optionally designed such that an electric motor with associated mechanics can convert electrical power into mechanical power.

The actuator can be a rotary electromechanical actuator (REMA), wherein the conversion unit is a permanent-magnet synchronous motor (PMSM) arranged and configured to drive a gearbox of the actuator.

The actuator can be a linear electromechanical actuator (LEMA), wherein the conversion unit is a permanent-magnet synchronous motor (PMSM) arranged and configured to drive a spindle of the actuator.

The actuator can be an electrohydraulic actuator (EHA), wherein the conversion unit is a permanent-magnet synchronous motor (PMSM) arranged and configured to drive a hydraulic pump of the actuator, and the hydraulic pump is configured and arranged to drive or supply a hydraulic cylinder of the actuator.

The actuator can be an electric motor pump (EMP), wherein the conversion unit is a permanent-magnet synchronous motor (PMSM) arranged and configured to drive a hydraulic pump of the actuator.

The actuator can be a servo-hydraulic actuator with a “Remote Electronic Unit” (REU).

The actuator can be a servo-hydraulic actuator (SHA), wherein the conversion unit is an electromagnetically controlled hydraulic amplifier unit that comprises a servo valve and a hydraulic cylinder.

Optionally, the actuator system comprises multiple of the aforementioned actuators, control units, and/or electronics units, which can each be of the same design or of different designs.

In one embodiment of the actuator system, the control unit may have multiple power stages and multiple communication interfaces in order to drive multiple actuators. The control unit can be arranged integrated in a “cabinet”.

It is also conceivable that, in one embodiment of the actuator system, multiple electronics units of different actuators are communicatively connected via a bus to a single control unit. Instead of multiple communication interfaces, multiple electronics units can be connected by different actuators in parallel or serial to the bus.

All control units and/or electronics units of the actuator system can be of identical design, i.e. implemented similarly.

For example, if in one embodiment of the actuator system multiple control units and/or multiple electronics units are present, the control units and/or electronics units can be implemented dissimilarly, optionally to achieve the necessary safety.

Optionally, the control unit comprises a monitoring unit and the actuator system has a further electronics unit, which are configured to monitor the conversion unit.

Optionally, the actuator system has a backup control unit and/or a further electronics unit, which are configured to perform the same functions as the control unit and/or at least one of the electronics units, and/or the backup control unit is configured to select whether a first channel or a second channel obtains control over the actuator.

The disclosure also relates to an aircraft, for example an airplane, having an actuator system or multiple actuator systems according to the disclosure.

The disclosure further relates to a method for operating an actuator system according to the disclosure, wherein an integrity of a signal of a sensor, for example of a motor position sensor, is checked by a sensorless control, a correlation, and/or a SIN²+COS² monitoring.

Control commands in the form of aircraft (A/C) communication information can be transmitted to the control unit.

Optionally, based on control commands and on the information provided via the electronics unit, the control unit, via the controller through a power stage, controls or regulates the electrical power delivered to the actuator or the conversion unit.

In the case of an actuator configured as an EMA or as an EHA, a position control, a speed control and/or a torque control can be carried out.

In the case of an actuator configured as an EMP, a pressure control and/or a flow control can be carried out.

It is pointed out that the terms “a” and “an” do not necessarily refer to exactly one of the elements, even though this is one possible embodiment, but can also denote a plurality of the elements. Likewise, the use of the plural also includes the presence of the element in question in the singular, and vice versa, the singular encompasses multiple instances of the element in question. Furthermore, all features of the disclosure described herein can be combined with one another arbitrarily or claimed separately from one another.

### BRIEF DESCRIPTION OF THE FIGURES

Further advantages, features and effects of the present disclosure will become apparent from the following description of exemplary embodiments with reference to the figures. In the figures, identical or similar components are designated by the same reference numerals. The figures show:

FIG. 1: a schematic representation of an embodiment of an actuator system according to the disclosure.

FIG. 2: a schematic representation of an embodiment of an actuator system according to the disclosure.

FIG. 3: a schematic representation of an embodiment of an actuator system according to the disclosure.

FIG. 4: a schematic representation of an embodiment of an actuator system according to the disclosure.

FIG. 5: a schematic representation of an embodiment of an actuator system according to the disclosure.

FIG. 6: a view of an embodiment of an electronics unit of an actuator system according to the disclosure.

### DETAILED DESCRIPTION

The embodiment of the actuator system shown in FIG. 1 comprises an actuator 1 and a control unit 4.

The actuator 1 comprises an electronics unit 2 and a conversion unit 3. The control unit 4 has two communication interfaces COM, wherein the control unit 4 is connected via one of these communication interfaces COM to a central computing unit of the aircraft (for example, a flight control computer (FCC) of the aircraft (A/C)) and via the other communication interface COM to the electronics unit 2.

Via the communication interface COM through which the control unit 4 is connected to the central computing unit, data can be exchanged between the control unit 4 and the central computing unit. For example, control commands from the central computing unit can be transmitted to the control unit 4, or data can be transmitted from the control unit 4 to the central computing unit. Via the communication interface COM through which the control unit 4 is connected to the electronics unit 2, data can be exchanged between the control unit 4 and the electronics unit 2. For example, data can be transmitted from the electronics unit 2 to the control unit 4 and/or from the control unit 4 to the electronics unit 2.

The control unit 4 comprises a controller 41 and a power stage 42.

The power stage 42 is supplied with electrical energy via a power supply and is connected to the conversion unit 3 in order to provide the conversion unit 3 with electrical energy.

The controller 41 is configured to control the power stage 42 so as to supply the conversion unit 3 with the desired electrical energy.

The conversion unit 3 converts the electrical energy into mechanical energy.

The electronics unit 2 has a communication interface COM by which it is communicatively connected to the control unit 4.

The controller 41 is connected to both communication interfaces COM of the control unit 4.

The communication interfaces COM of the control unit 4 and of the electronics unit 2 are digital interfaces.

The electronics unit 2 further has two IN interfaces by which it is connected to the conversion unit 3 to sense states of the conversion unit 3, e.g. via sensors, and an OUT interface by which the electronics unit 2 can actuate the conversion unit 3. For example, via the OUT interface a locking unit of the conversion unit 3, e.g. a brake, can be actuated.

The electronics unit 2 has a memory (DATA); for instance, one or more properties of the actuator and/or the conversion unit are stored as data in the DATA memory.

The electronics unit 2 further has a processing unit 21, which is connected to the COM interface of the electronics unit 2, to the other IN/OUT interfaces, and to the DATA memory.

FIG. 1 illustrates an embodiment in which a single communication channel exists between the control unit 4 and the actuator 1, in the form of a connection via COM interfaces between the electronics unit 2 and the control unit 4.

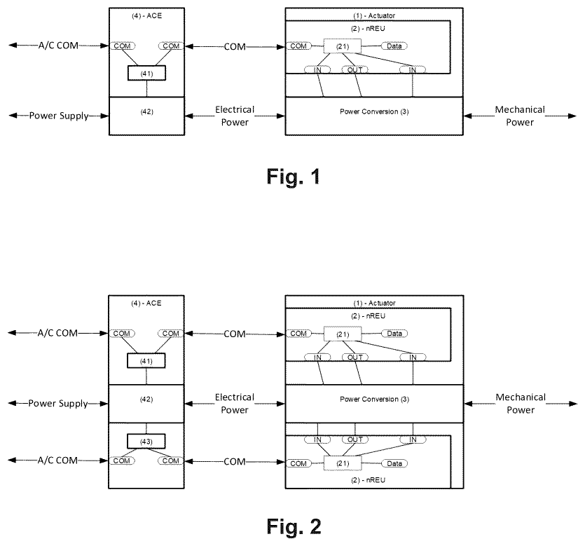

The basic structure of the embodiment shown in FIG. 2 is the same as that of FIG. 1; to avoid repetition, reference is made to the description of FIG. 1 for this basic structure.

In the embodiment shown in FIG. 2, however, two communication channels are present between the control unit 4 and the actuator 1.

For this purpose, the actuator 1 includes a second electronics unit 2.

The second electronics unit 2 has the same components as the first electronics unit 2 of the embodiment of FIG. 2, i.e., as the single electronics unit 2 of FIG. 1, and is connected to the conversion unit 3 in the same way. The two electronics units 2 of the embodiment of FIG. 2 can be identical in design.

The control unit 4, in the FIG. 2 embodiment, has two additional communication interfaces COM. The control unit 4 is connected via one of these additional COM interfaces to the central computing unit of the aircraft, and via the other additional COM interface to the second electronics unit 2, i.e. to the COM interface of the second electronics unit 2.

The control unit 4 further includes a monitoring unit 43, which is connected to the two additional COM interfaces and to the power stage 42.

Via the second electronics unit 2 in the actuator 1 and the monitoring unit 43 in the control unit 4, independent information about the state(s) of actuator 1 can be provided to the central computing unit, in addition to the information provided by the controller 41.

Thus, the embodiment in FIG. 2 implements a COM/MON architecture, wherein one channel serves as a command channel (COM) and one as a monitor channel (MON) between the control unit 4 and the actuator 1.

This architecture can also be referred to as a CON/MON architecture, where the command channel is referred to as a control channel.

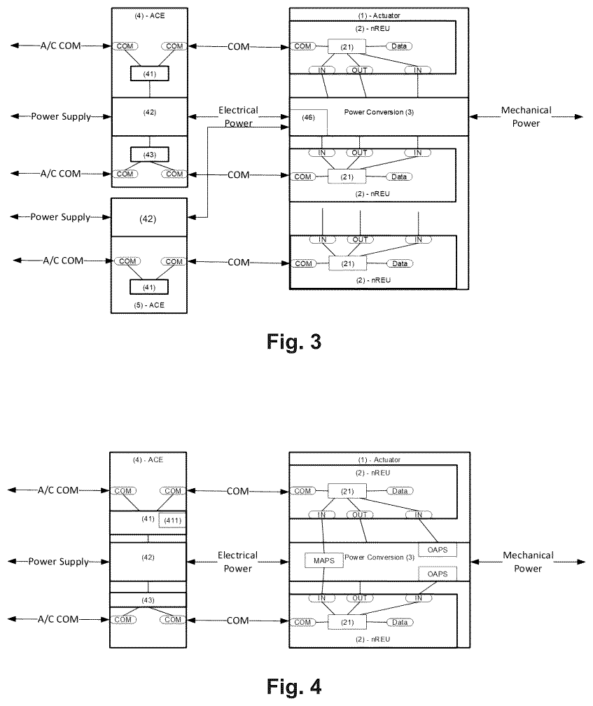

The basic structure of the embodiment shown in FIG. 3 is the same as that of FIG. 2; for the description of this basic structure, reference can be made to the description of FIG. 2.

In the embodiment shown in FIG. 3, a backup control unit 5 is present, which has the same structure as the control unit 4 of FIG. 1.

The power stage 42 of the backup control unit 5 is connected, like the power stage 42 of the control unit 4, to the conversion unit 3 in order to supply the conversion unit 3 with electrical energy. The conversion unit 3 has a switch 46 to switch between the two energy sources.

The actuator 1 includes a third electronics unit 2, which has the same elements as the electronics unit 2 of the FIG. 1 embodiment and is connected to the conversion unit 3 in the same way.

The backup control unit 5 has two communication interfaces COM; the backup control unit 5 is connected via one of these COM interfaces to the central computing unit of the aircraft and via the other COM interface to the third electronics unit 2, i.e. to the COM interface of the third electronics unit 2.

Via the third electronics unit 2 in the actuator, secure information (voting) can be provided, and/or an emergency operation can be realized via the backup control unit 5.

The backup control unit 5 has the same architecture as the control unit 4 of the FIG. 1 embodiment.

The backup control unit 5 can be part of the control unit 4 or arranged separately from the control unit 4.

The switch 46 of the conversion unit 3 is configured to switch over to the backup control unit 5. The switching function can also be implemented in the control unit 4.

Thus, the embodiment in FIG. 3 implements a COM/MON/Backup architecture, wherein a command channel and a monitor channel are present between the control unit 4 and the actuator 1, and a backup channel is present between the backup control unit 5 and the actuator 1.

This architecture can also be referred to as a CON/MON/Backup architecture, where the command channel is referred to as a control channel.

The embodiment of FIG. 4 is similar to the embodiment of FIG. 2; with regard to FIG. 4 reference is essentially made to the description of FIG. 2.

In the embodiment of FIG. 4, the controller 41 additionally has a regulation unit 411 for sensorless control. The conversion unit 3 has exactly one conversion-unit position sensor in the form of a motor position sensor (MAPS) to detect the position of the conversion unit 3, specifically, the position of a motor of the conversion unit 3. Furthermore, two actuator output position sensors (OAPS) are provided to detect the position of the mechanical actuator output. The motor position sensor MAPS is connected to one IN interface of each of the two electronics units 2.

Each actuator output position sensor OAPS is connected to an IN interface of one of the electronics units 2. Each actuator output position sensor OAPS can also be referred to as an “Output Angular Position Sensor.” Each actuator output position sensor is optionally a rotation sensor or a rotational speed sensor.

Each motor position sensor MAPS can also be referred to as a “Motor Angular Position Sensor.” Each motor position sensor is optionally a rotation sensor or a rotational speed sensor.

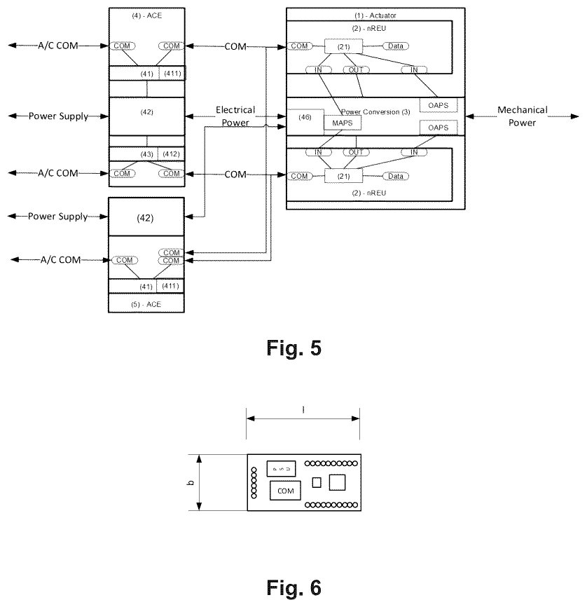

The embodiment of FIG. 5 is essentially a combination of the embodiments of FIG. 3 and FIG. 4; accordingly, for the description of FIG. 5, reference is made to the descriptions of FIG. 3 and FIG. 4.

The controller 41 of the control unit 4, compared to the controller 41 of FIG. 3, includes a regulation unit 411 for sensorless control.

The monitoring unit 43 of the control unit 4, compared to the monitoring unit 43 of FIG. 3, includes a sensing unit 412 for sensorless sensing.

The backup control unit 5, compared to the backup control unit 5 of FIG. 3, has an additional COM interface, and the backup control unit 5 is connected via this additional COM interface to both COM interfaces of the two electronics units 2.

The actuator 1 in FIG. 5 is configured as in FIG. 4.

Optionally, for each actuator, only exactly one motor position sensor MAPS or only exactly one actuator output position sensor OAPS is present.

In the actuator system according to FIGS. 4 and 5, two redundant channels are present, which are depicted in FIGS. 4 and 5 by the double arrows labeled COM.

According to FIG. 5, a selection unit in the form of the backup control unit 5 can be provided to select whether the first channel or the second channel obtains control over the actuator.

The backup control unit 5 can receive from both electronics units 2 information about the state detected by the single motor position sensor MAPS, for example, in the form of a rotational speed value provided by each electronics unit 2. The backup control unit 5 is designed to make a decision, based on these rotational speed values, as to whether the first channel or the second channel gets to control the actuator 1.

A correlation principle can also be applied, and/or the MAPS and/or OAPS sensors provide integrity information, e.g. SIN and COS signals, which allows a SIN²+COS² monitoring to be performed.

Since the position evaluation now involves electronic components such as microcontrollers or FPGAs, a faulty but valid position must be anticipated. In the COM/MON and COM/MON/Backup architectures, optionally only one motor position sensor is used, which can be evaluated by all electronics units if necessary.

It is possible to verify the integrity of the motor position sensor's signal in a sensorless manner as follows:
Optionally, the command (control) channels are equipped with a sensorless control that allows determination of the motor position. Optionally, for this purpose the controller has a regulation unit for sensorless control.
Optionally, for example with the COM/MON architecture, a safe fault detection is possible.
Additionally, the monitor channel can determine the motor position from the output voltage and output current information, and detect the motor position via sensorless sensing.
This makes it possible to isolate a potential fault and continue operation.

It is possible to verify the integrity of the motor position sensor's signal by correlation as follows.
Optionally, the cumulative position of the motor detected by the motor position sensor is compared with the positions detected by the first actuator output position sensor and the second actuator output position sensor. An error can thereby be detected, although not all errors of the motor position sensor can be isolated. For example, an offset error cannot be identified.
A backup mode of operation cannot be realized in this case.
The correlation can also be achieved using one actuator output position sensor and two motor position sensors; however, in that case the offset problem shifts to the output.

It is possible to verify the integrity of the motor position sensor's signal by SIN²+COS² monitoring as follows:
For this purpose, the motor position sensor provides SIN and COS signals to both electronics units, and each electronics unit is able to determine the integrity independently.
The same is possible for the actuator output position sensor as well.

Optionally, communication can be distributed over multiple channels. For example, the backup channel receives information from all electronics units and can ensure continued operation by means of the sensorless control that is also present.

The control unit optionally has isolation functions to disconnect the communication of a faulty participant in the event of a failure. For example, if the command channel fails, it disconnects from the bus and the backup channel can take over control. The decision can be made via a voting among the command channel, backup channel, and monitor channel.

With two information values, a clear fault identification can be achieved by correlating the actuator output position sensors, wherein a value from the first actuator output position sensor is compared with a value from the second actuator output position sensor, and/or by means of the motor position sensor, wherein a value of the motor position sensor is compared with a value of the first actuator output position sensor and with a value of the second actuator output position sensor.

With three information values, a clear fault isolation can be achieved through a sensorless method using the actuator output position sensors, wherein a value of the first actuator output position sensor is compared with a value of the second actuator output position sensor and a value of the second actuator output position sensor is compared with a value of a confirmed motor position, and/or wherein a value of the motor position determined sensorlessly by the control unit is compared with a value of the motor position determined sensorlessly by the backup control unit.

In FIG. 6, the electronics unit shown has a circuit board on which the components of the electronics unit are arranged.

The electronics unit can be easily integrated into the actuator, for example due to its small installation space (compact size).

Optionally, the electronics unit or the presented concept allows new sensors to be easily integrated into the actuator.

1. An actuator system, comprising an actuator that comprises a conversion unit for converting electrical and/or hydraulic power into mechanical power, and a control unit for supplying the conversion unit with electrical power and/or for controlling the conversion unit, wherein the actuator system comprises an electronics unit arranged separately from the power unit, which is configured to detect one or more states of the actuator and/or the conversion unit, convert the detected state or states into data, and transmit the data digitally to the control unit, wherein the electronics unit comprises a memory in which one or more properties of the actuator and/or the conversion unit are stored as data, and the electronics unit is configured to transmit one, multiple, or all of the stored data to the control unit, and wherein the control unit is configured to regulate and/or control the actuator and/or the conversion unit.

2. The actuator system according to claim 1, wherein the control unit and the electronics unit each comprise a digital communication interface and are connected via these communication interfaces such that data can be transmitted from the electronics unit to the control unit and/or from the control unit to the electronics unit.

3. The actuator system according to claim 1, wherein the electronics unit is configured to execute simple actuations in the form of a digital on-off actuation.

4. The actuator system according to claim 1, wherein the state or states include a position of the conversion unit, a position of the actuator, a temperature of the actuator, a force acting on the actuator, a torque acting on the actuator, an electrical voltage present at the actuator, an electric current flowing through the actuator, an acceleration, and/or a humidity.

5. The actuator system according to claim 1, wherein the actuator comprises one or more additional mechanical and/or hydraulic conversion units.

6. The actuator system according to claim 1, wherein the control unit comprises a power stage which is configured to supply the conversion unit with electrical energy.

7. The actuator system according to claim 1, wherein the actuator system comprises one or more sensors which are connected to the electronics unit and arranged such that the electronics unit can detect the state or states of the actuator and/or the conversion unit by means of the sensor or sensors, and wherein the sensor is configured and arranged to detect the state or multiple states, or each of the sensors is configured and arranged to detect one or more of the states.

8. The actuator system according to claim 7, wherein for the detection of at least one state of the actuator, only exactly one sensor is provided in each case.

9. The actuator system according to claim 1, wherein the electronics unit is part of the actuator and/or is arranged in one structural unit with the actuator and/or the conversion unit.

10. The actuator system according to claim 1, wherein all components of the actuator system are arranged in one structural unit, or at least one component of the actuator system is arranged separately from the other components of the actuator system.

11. The actuator system according to claim 1, wherein the conversion unit is an electric motor or a hydraulic unit with a hydraulic valve and a hydraulic cylinder.

12. The actuator system according to claim 1, wherein the actuator has a gearbox and/or a spindle, wherein the conversion unit is configured and arranged to drive the gearbox and/or the gearbox is configured and arranged to drive the spindle, or wherein the actuator has a hydraulic pump and/or a hydraulic cylinder, wherein the conversion unit is configured and arranged to drive the hydraulic pump and/or the hydraulic pump is configured and arranged to drive and/or supply the hydraulic cylinder with hydraulic power.

13. The actuator system according to claim 1, wherein the actuator system comprises multiple of said actuators, control units, and/or electronics units, wherein these are each implemented in the same design or in different designs.

14. The actuator system according to claim 1, wherein the control unit has a monitoring unit and the actuator system has a further electronics unit, which are configured to monitor the conversion unit.

15. The actuator system according to claim 13, wherein the actuator system has a backup control unit and/or a further electronics unit, which are configured to perform the same functions as the control unit and/or at least one of the electronics units, and/or wherein the backup control unit is configured to select whether a first channel or a second channel obtains control over the actuator.

16. An aircraft, comprising one or more actuator systems according to claim 1.

17. A method for operating the actuator system according to claim 1, wherein an integrity of a signal of a sensor is checked by a sensorless control, a correlation, and/or a SIN²+COS² monitoring.

18. The actuator system according to claim 1, wherein the actuator system is an actuator system for an aircraft.

19. The actuator system according to claim 1, wherein the electronics unit is configured to transmit one, multiple, or all of the stored data to the control unit upon request of the control unit.

20. The actuator system according to claim 1, wherein the control unit is configured to regulate and/or control the actuator and/or the conversion unit based on data transmitted by the actuator and/or the electronics unit and/or based on control commands transmitted to the control unit.
